(19) United States
(12) Patent Application Publication
(10) Pub. No.: US 2012/0186563 A1
(43) Pub. Date: Jul. 26, 2012

(54) CANISTERS

(75) Inventors: Masakazu HASEGAWA, Miyoshi-shi (JP); Hiroshi SUGIURA, Nagoya-shi (JP); Hiroshi TAKAMATSU, Chiryu-shi (JP); Masahiro SUGIURA, Anjo-shi (JP)

(73) Assignee: AISAN KOGYO KABUSHIKI KAISHA, Obu-shi (JP)

(21) Appl. No.: 13/355,733

(22) Filed: Jan. 23, 2012

(30) Foreign Application Priority Data
Jan. 21, 2011 (JP) 2011-010618

(51) Int. Cl. F02M 33/04; B01D 53/02

(52) U.S. Cl. 123/519; 96/130

(57) ABSTRACT

A canister has a canister case, an adsorbent chamber defined in the canister case, and an adsorbent disposed in the adsorbent chamber. The adsorbent can adsorb fuel vapor as the fuel vapor flows through the adsorbent chamber in a first direction. On the other hand, the adsorbent allows desorption of fuel vapor as air flows through the adsorbent in a second direction opposite to the first direction. The adsorbent chamber includes a first adsorbent chamber and a second absorbent chamber communicating with each other. The first adsorbent chamber is disposed on an upstream side of the second adsorbent chamber with respect to the first direction. The adsorbent includes a first adsorbent disposed in the first adsorbent chamber and a second adsorbent disposed in the second adsorbent chamber. A desorption promoting device is disposed in the second adsorbent chamber and can promote desorption of fuel vapor from the second adsorbent.

### CROSS-REFERENCES TO RELAYED APPLICATIONS

This application claims priority to Japanese Patent Application Serial Number 2011-010618, the contents of which are incorporated herein by reference.

### BACKGROUND OF THE INVENTION

1. Field of the Invention

The present invention relates to a canister used in a fuel vapor processing apparatus of an internal combustion engine that is installed, for example, on a vehicle such as an automobile.

2. Description of the Related Art

Fuel vapor may be generated through evaporation of gasoline fuel stored in a fuel tank during stopping of an internal combustion engine (hereinafter simply referred to as an engine). A known canister can prevent fuel vapor from dissipating into the atmosphere by adsorbing fuel onto an adsorbent, such as activated carbon, accommodated in an adsorbent chamber of the canister. In addition to the adsorbent chamber, the canister is equipped with a tank port communicating with an upper gaseous chamber of the fuel tank, a purge port communicating with an intake air passage of the internal combustion engine, and an atmosphere port open to the atmosphere. The adsorbent chamber accommodates the adsorbent onto which fuel vapor flowing from the tank port to the atmosphere port is adsorbed and from which the fuel vapor is desorbed when air from the atmosphere port is drawn to the purge port. Accordingly, the fuel vapor generated in the fuel tank, for example, during stopping of the engine, may be adsorbed onto the adsorbent as it flows from the tank port to the atmosphere port via the adsorbent chamber, whereby it is possible to prevent the fuel vapor from dissipating into the atmosphere. Further, fuel adsorbed onto the adsorbent may be desorbed (purged) as the air in the atmosphere is introduced into the atmosphere port and passes through the adsorbent chamber so as to be drawn into the purge port by the intake negative pressure during the operation of the engine, whereby the adsorbent is reconditioned.

In some cases, a blow-through phenomenon (hereinafter simply referred to as blow-through) may occur to the canister. The blow-through is a phenomenon in which the fuel vapor adsorbed onto the adsorbent during stopping of the engine is dissipated into the atmosphere via the atmosphere port. As for the distribution of the density of the fuel vapor adsorbed onto the adsorbent, the density is highest on the tank port side and tends to gradually decrease toward the atmosphere port side. However, due to adsorption equilibrium of the adsorbent, a migration phenomenon may progress as time passes. The migration phenomenon is a phenomenon in which the fuel vapor is diffused or moved toward the atmosphere port, where the density is low. As a result, the blow-through is likely to occur. Further, if, at the time of purging, the fuel vapor cannot be completely desorbed but partly remains on the adsorbent, a part of the fuel vapor remaining on the adsorbent may be diffused or moved toward the atmosphere port by newly introduced fuel vapor flowing from the fuel tank during filling of fuel or other occasion. Also in this case, the blow-through may occur. Thus, the larger the amount of fuel vapor remaining on the adsorbent on the atmosphere port side (hereinafter referred to as the “residual amount”), the larger the amount of fuel vapor that may blow through (hereinafter referred to as the “blow-through amount”).

Japanese Laid-Open Patent Publication No. 2003-3914 discloses a canister configured to prevent blow-through of fuel vapor. According to the canister disclosed in this publication, there is provided a first adsorbent chamber and a second adsorbent chamber. The first adsorbent chamber has a flow path formed therein, an atmospheric air introduction portion provided at one end of the flow path for introducing atmospheric air, an evaporation fuel introduction portion and an evaporation fuel discharge portion provided at the other end of the flow path for introducing fuel vapor and for discharging the fuel vapor respectively, and a tubular portion extending in the main flow direction of the flow path and filled with a first adsorbent onto and from which the fuel vapor is adsorbed and desorbed. The second adsorbent chamber is arranged in series with the first adsorbent chamber on the atmospheric air introduction portion side of the first adsorbent chamber and is filled with a second adsorbent of higher adsorption ability than the first adsorbent.

In the canister disclosed in the above publication, the second adsorbent chamber arranged in series with the first adsorbent chamber and on the atmospheric air introduction portion side thereof is filled with the second adsorbent of higher adsorption ability than the first adsorbent; however, in the case of an adsorbent of high adsorption ability, the fuel vapor adsorbed onto the same tends not to be easily desorbed, which means that the desorption ability is low. Thus, the residual amount of fuel vapor is relatively large, causing an increase in blow-through amount. On the other hand, in the case of an adsorbent of low adsorption ability, the fuel vapor adsorbed onto the same tends to be easily desorbed, which means that the desorption ability is high and the residual amount of fuel vapor is small. However, when a large amount of fuel vapor is generated during filling of fuel or like occasion, the fuel vapor may not be sufficiently adsorbed, which also results in an increase in blow-through amount. In view of this, there has conventionally been common practice to use, as an adsorbent capable of achieving a reduction in blow-through amount to some degree and capable of reducing the residual amount, an activated carbon (hereinafter referred to as common activated carbon) exhibiting an adsorption ability, for example, of 8 to 12 g/dL in terms of butane working capacity in the ASTM method; however, due to its low adsorption ability, such common activated carbon cannot be said to reduce the blow-through amount to a sufficient degree. In this specification, “butane working capacity in the ASTM method” refers to effective butane adsorption amount as measured in accordance with Standard No. D5228 as formulated and issued by the ASTM International (formerly called the American Society for Testing and Materials).

Therefore, there has been a need in the art for a canister capable of reducing both of a blow-through amount and a residual amount.

### SUMMARY OF THE INVENTION

According to the present teachings, a canister has a canister case, an adsorbent chamber defined in the canister case, and an adsorbent disposed in the adsorbent chamber. The adsorbent can adsorb fuel vapor as the fuel vapor flows through the adsorbent chamber in a first direction. On the other hand, the adsorbent allows desorption of fuel vapor 1 as air flows through the adsorbent in a second direction opposite to the first direction. The adsorbent chamber includes a first adsorbent chamber and a second absorbent chamber communicating with each other. The first adsorbent chamber is disposed on an upstream side of the second adsorbent chamber with respect to the first direction. The adsorbent includes a first adsorbent disposed in the first adsorbent chamber and a second adsorbent disposed in the second adsorbent chamber. A desorption promoting device is disposed in the second adsorbent chamber and can promote desorption of fuel vapor from the second adsorbent.

### BRIEF DESCRIPTION OF THE DRAWINGS

FIG. 1 is a sectional view of a canister according to a first example;

FIG. 2 is a sectional view of a canister according to a second example;

FIG. 3 is a sectional view of a canister according to a third example;

FIG. 4 is a sectional view of a canister according to a fourth example;

FIG. 5 is a sectional view of a canister according to a fifth example;

FIG. 6 is a sectional view of a canister according to a sixth example; and

FIG. 7 is a sectional view of a canister according to a seventh example.

### DETAILED DESCRIPTION OF THE INVENTION

Each of the additional features and teachings disclosed above and below may be utilized separately or in conjunction with other features and teachings to provide improved canisters. Representative examples of the present invention, which examples utilize many of these additional features and teachings both separately and in conjunction with one another, will now be described in detail with reference to the attached drawings This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

In one example, a canister includes a canister case having a tank port communicating with an upper gaseous chamber of a fuel tank, a purge port communicating with an intake passage of an internal combustion engine, an atmosphere port open to the atmosphere. An adsorbent chamber is defined in the canister case and has an adsorbent disposed therein. The adsorbent can adsorb fuel vapor as the fuel vapor flows from the tank port to the atmosphere port The adsorbent allows desorption of the fuel vapor 1 as air is drawn from the atmosphere port into the purge port. The adsorbent chamber includes a first adsorbent chamber and a second absorbent chamber. The first adsorbent chamber communicates with the tank port and the purge port, and the second adsorbent chamber communicates with the atmosphere port. The adsorbent stored in the second adsorbent chamber is activated carbon having high adsorption ability. A desorption promoting device capable of promoting desorption of the fuel vapor is disposed within the second adsorbent chamber.

With this arrangement, because the adsorbent in the second adsorbent chamber is activated carbon having high adsorption ability, it is possible to ensure a higher adsorption ability as compared with a commonly used activated carbon. Further, due to the desorption promotion device provided in the second adsorbent chamber, desorption of fuel vapor is promoted. Hence, it is possible to compensate for relatively lower desorption ability of the activated carbon of high adsorption ability stored in the second adsorbent chamber. As a result, it is possible to reduce the blow-through amount because of the high adsorption ability while it is possible to reduce the residual amount. The desorption promotion device in the second adsorbent chamber may be of any type so long as it promotes desorption of fuel vapor from the activated carbon of high adsorption ability. For example, the desorption promotion device may include at least one of a heat storage device and a heating unit.

The activated carbon disposed in the second adsorbent chamber may include activated carbon having a high adsorption ability of 13 g/dL or more in terms of butane working capacity as measured by the ASTM method. With this arrangement, due to the activated carbon in the second adsorbent chamber, it is possible to ensure a higher adsorption ability than in the case of a commonly used activated carbon. In this specification, activated carbon whose butane working capacity as measured by the ASTM method is 13 g/dL or more is referred to as “activated carbon having a high adsorption ability” and an activated carbon whose butane working capacity as measured by the ASTM method is less than 13 g/dL is referred to as “activated carbon having a low adsorption ability.”

The adsorbent disposed in the first adsorbent chamber may include activated carbon having a lower adsorption ability in terms of butane working capacity as measured by the ASTM method as compared with the activated carbon stored in the second adsorbent chamber. With this arrangement, it is possible to use commonly used activated carbon as the adsorbent in the first adsorbent chamber. The canister may further include a desorption promoting device disposed within the first adsorbent chamber and capable of promoting desorption of the fuel vapor. With this arrangement, it is possible to reduce the residual amount of the activated carbon of low adsorption ability in the first adsorbent chamber. The desorption promotion device in the first adsorbent chamber may be of any type so long as it promotes desorption of fuel vapor from the activated carbon of low adsorption ability. For example, the desorption promotion device may include at least one of a heat storage unit and a heating unit.

In an alternative, the adsorbent disposed in the first adsorbent chamber may include activated carbon of high adsorption ability. With this arrangement, because the adsorbent in the first adsorbent chamber is an activated carbon of high adsorption capacity, it is possible to ensure a higher adsorption ability as compared with a commonly used activated carbon. In this case, the canister may further include a desorption promoting device disposed within the first adsorbent chamber and capable of promoting desorption of the fuel vapor. With this arrangement, desorption of fuel vapor is promoted by the desorption promotion device disposed in the first adsorbent chamber. Hence, it is possible to compensate for relatively lower desorption ability of the activated carbon of high adsorption ability stored in the first adsorbent chamber. As a result, it is possible to reduce the residual amount. The desorption promotion device in the first adsorbent chamber may be of any type so long as it promotes desorption of fuel vapor from the activated carbon of high adsorption ability. For example, the desorption promotion device may include at least one of a heat storage device and a heating unit.

A hollow chamber having no adsorbent disposed therein may be provided between the first adsorbent chamber and the second adsorbent chamber. With this arrangement, due to the hollow chamber provided between the first adsorbent chamber and the second adsorbent chamber, it is possible to prevent diffusion or movement of fuel vapor from the first adsorbent chamber to the second adsorbent chamber.

In another example, the canister case may include a first case having the tank port and the purge port, a second case having the atmosphere port, and a piping member communicating between the first case and the second case. With this arrangement, the first case and the second case can be arranged so as to be separated from each other. Further, due to the piping member communicating between the first case and the second case, it is possible to prevent diffusion or movement of fuel vapor from the first case to the second case.

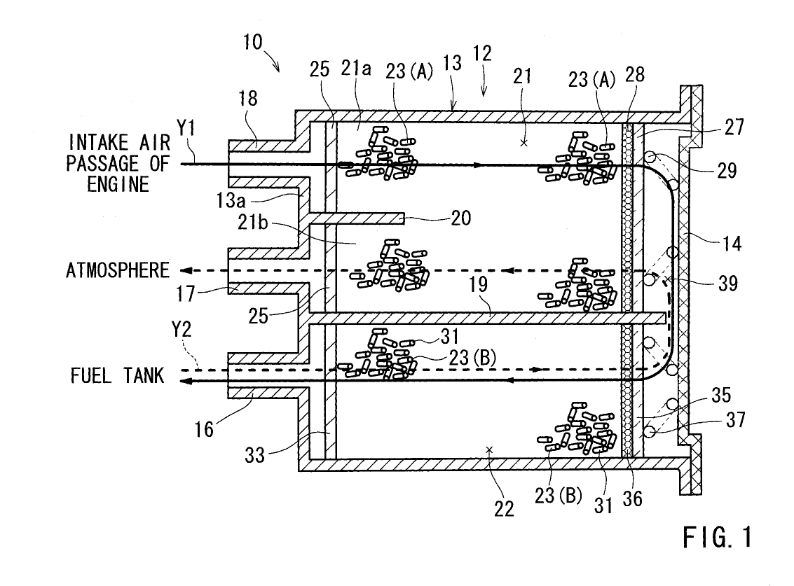

First to seventh examples will now be described with reference to FIGS. 1 to 7.

### FIRST EXAMPLE

A first example of the present invention will now be described. Referring to FIG. 1, there is shown a sectional view of a canister 10 according to the first example. The canister 10 may be installed on a vehicle, such as an automobile. In the following explanation, the left-hand side, the right-hand side, the lower side, and the upper side in FIG. 1 respectively will be referred to as the front side, the rear side, the left-hand side, and the right-hand side of the canister 10.

As shown in FIG. 1, the canister 10 includes a case 12. The case 12 may be made of resin and includes a bottomed-box-like case main body 13 and a cover plate 14 closing an open end of the case main body 13. In this example, the bottom side of the case main body 13 is oriented forwards (to the left in FIG. 1), and the cover plate 14 is oriented rearward (to the right in FIG. 1).

An end plate 13a on the front side (the left-hand side in FIG. 1) of the case main body 13 has three ports 16, 17, and 18 protruding forwards (to the left in FIG. 1) and arranged side by side in the left and right direction. The left-hand side port 16 serves as an atmosphere port 16. The atmosphere port 16 is open to the atmosphere. The right-hand side port 18 serves as a tank port 18. The tank port 18 communicates with an upper gaseous chamber (air layer chamber) within a fuel tank (not shown) via a fuel vapor gas passage (not shown). Fuel vapor gas containing fuel vapor generated in the fuel tank is introduced into the case main body 13 from the tank port 18 via the fuel vapor gas passage. The central port 17 serves as a purge port 17. The purge port 17 communicates with an intake air passage of an engine (not shown) via a purge passage (not shown). In the midpoint of the purge passage, there is provided a purge control valve (not shown) configured to open and close the purge passage. An electronic control unit (ECU) (not shown) controls the degree of opening of the purge control valve during the operation of the engine, whereby a purge control can be preformed. In this specification, the term “engine” is used to mean an internal combustion engine.

The end plate 13a on the front side of the case main body 13 has a left-hand side partition wall 19 and a right-hand side partition wall 20 each protruding rearward (to the right in FIG. 1). The leading end portion (the rear end portion) of the partition wall 19 on the left-hand side (the lower side in FIG. 1) extends to a position proximal to the cover plate 14. The left-hand side partition wall 19 divides the interior of the case main body 13 into a first chamber 21 communicating with the purge port 17 and the tank port 18 and a second chamber 22 communicating with the atmosphere port 16. The partition wall 20 on the right-hand side (the upper side in FIG. 1) is formed so as to protrude by a smaller protrusion amount than the left-hand side partition wall 19 (e.g., by a protrusion amount which is approximately ¼ of the protrusion amount of the left-hand side partition wall 19). The right-hand side partition wall 20 divides the front end portion (the port side end portion) of the first chamber 21 into an inlet region 21 a on the tank port 18 side and an outlet region 21b on the purge port 17 side.

An adsorbent 23(A) is accommodated within the first chamber 21 and can adsorb fuel vapor generated in the fuel tank. Fuel vapor adsorbed onto the adsorbent 23 can be desorbed as will be explained later. As the adsorbent 23(A), activated carbon in a form of activated carbon granules (also indicated by reference numeral 23(A)) may be used. The activated carbon can adsorb a fuel component, such as butane, contained in a fuel vapor containing gas. The activated carbon 23(A) used in the first chamber 21 has a low adsorption ability of less than 13 g/dL in terms of butane working capacity as measured by the ASTM method. The activated carbon 23(A) of low adsorption capacity may be a commonly used activated carbon having a butane working capacity of 8 to 12 g/dL as measured by the ASTM method. The first chamber 21 may be also called “first adsorbent chamber”.

Within the inlet region 21a and the outlet region 21b of the first chamber 21, there are respectively arranged adsorbent retaining filters 25 interposed between the activated carbon 23(A) of low adsorption capacity and the end plate 13a. The filters 25 may be formed, for example, of non-woven fabric. An air-permeable plate member 27 for pressing the adsorbent is fitted into the rear end region of the first chamber 21 so as to be movable in the forward and rearward direction (the left and right direction as seen in FIG. 1). For example, the air-permeable plate member 27 may be a lattice-like plate made of resin. Between the air-permeable plate member 27 and the activated carbon 23(A) of low adsorption capacity, there is provided an adsorbent retaining filter 28. The filter 28 may be made, for example, of urethane foam. Further, a spring 29 is interposed between the air-permeable plate member 27 and the cover plate 14. The spring 29 resiliently forwardly presses the air-permeable plate member 27 to the left as seen in FIG. 1.

An adsorbent 23(B) capable of adsorbing fuel vapor generated in the fuel tank and allowing fuel vapor from being desorbed, and a heat storage material 31 capable of absorbing and releasing latent heat in response to change in temperature, are accommodated in the second chamber 22 in a mixed state. As the adsorbent 23(B), activated carbon in a form of activated carbon granules (also indicated by numeral 23(B)) capable of adsorbing a fuel component, such as butane, contained in the fuel vapor gas may be used. The activated carbon 23(B) used in the second chamber 22 may have a high adsorption ability of not less than 13 g/dL in terms of butane working capacity as measured by the ASTM method. More preferably, the activated carbon 23(B) of high adsorption capacity in the second chamber 22 may be activated carbon of high adsorption ability in terms of a butane working capacity as measured by the ASTM method of 15 g/dL or more; and, most preferably, activated carbon of high adsorption ability having a butane working capacity as measured by the ASTM method of 17 g/dL or more. As the activated carbon 23(A) of low adsorption ability in the first chamber 21 and the activated carbon 23(B) of high adsorption ability in the second chamber 22, activated carbons having an equivalent specific heat may be used. Further, as compared with a commonly used activated carbon, the activated carbon 23(B) of high adsorption capacity provides a stronger intermolecular force for the residual part of the fuel vapor as the butane working capacity as measured by the ASTM method increases, so that it is possible to reduce the fuel diffusion amount, resulting in a reduction in the blow-through amount. The second chamber 22 may be called a “second adsorbent chamber.”

As the heat storage material 31, any heat storage material may be used as long as it includes a phase change substance capable of absorbing and releasing latent heat in response to change in temperature. For example, the heat storage material may be a phase change substance, microcapsules each sealingly containing a phase change substance, and pellets each sealingly containing the microcapsules or the phase change substance. There are no limitations regarding the configuration and arrangement of the heat storage material 31. The phase change substance may be paraffin, such as heptadecane having a melting point of 22° C., octadecane having a melting point of 28° C., etc. Further, by utilizing the latent heat of the heat storage material 31, it is possible to suppress increase in temperature of the activated carbon 23(B) of high adsorption ability to promote adsorption of fuel vapor during adsorption. On the other hand, it is possible to suppress decrease in temperature of the activated carbon 23(B) of high adsorption ability to promote desorption of fuel vapor during desorption. The heat storage material 31 may be called a “desorption promotion device” or a “heat storage device.”

An adsorbent retaining filter 33 is disposed within the front end region of the second chamber 22 so as to be interposed between the end plate 13a and the mixture of the activated carbon 23(B) of high adsorption ability and the heat storage material 31. Further, a lattice-like air-permeable plate member 35 for pressing the adsorbent is fitted into the rear end region of the second chamber 22 so as to be movable in the forward and rearward direction (in the left and right direction as seen in FIG. 1). Further, an adsorbent retaining filter 36 is interposed between the air-permeable plate member 35 and the mixture of the activated carbon 23(B) of high adsorption ability and the heat storage material 31. The filter 36 may be made of urethane foam. Further, a spring 37 is interposed between the air-permeable plate member 35 and the cover plate 14. The spring 37 resiliently forwardly presses the air-permeable plate member 35 to the left as seen in FIG. 1. Further, a communication passage 39 is defined between the cover plate 14 and air-permeable plate members 27 and 35 of the two chambers 21 and 22 for communication between the two chambers 21 and 22.

Next, the operation of the canister 10 will be described. During filling of fuel or during a normal state (e.g., during parking), the fuel vapor gas containing the fuel vapor generated in the fuel tank is introduced into the first chamber 21 via the tank port 18 (see the solid-line arrow Y1 in FIG. 1). The fuel vapor gas then flows through the first chamber 21, the communication path 39 and the second chamber 22. As the fuel vapor gas flows in this way, the fuel vapor contained in the fuel vapor gas is adsorbed onto the activated carbon 23(A) of low adsorption ability contained in the first chamber 21 and onto the activated carbon 23(B) of high adsorption ability contained in the second chamber 22. Due to the latent heat of the heat storage material 31 contained in the second chamber 22, increase in temperature of the activated carbon 23(B) of high adsorption ability during adsorption of the fuel vapor may be suppressed, so that adsorption of fuel vapor can be promoted. After that, the fuel vapor gas, which now substantially consists only of air, is discharged to the atmosphere from the atmosphere port 16.

If the purge control valve (not shown) is opened under the control of the electronic control unit (ECU) during the purging operation (i.e., the purge control operation during the operation of the engine), the intake negative pressure of the engine is introduced into the first chamber 21 via the purge port 17, whereby air in the atmosphere flows through the second chamber 22, the communication path 39, and the first chamber 21 opposite to the flow of the fuel vapor gas (see the dotted-line arrow Y2 in FIG. 1). As the air flows in this way, fuel vapor is desorbed (purged) from the activated carbon 23(A) of low adsorption ability contained in the first chamber 21 and the activated carbon 23(B) of high adsorption ability contained in the second chamber 22. The desorbed fuel vapor is then supplied together with air to the intake air passage of the engine from the purge port 17. Due to the latent heat of the heat storage material 31 contained in the second chamber 22, reduction in temperature of the activated carbon 23(B) of high adsorption ability during desorption of the fuel vapor may be suppressed, so that desorption of the fuel vapor is promoted.

With above-described canister 10, the adsorbent in the second chamber 22 is the activated carbon 23(B) of high adsorption ability, and therefore, as compared with the case of using a commonly used activated carbon, it is possible to ensure a higher adsorption ability. In addition, due to the heat storage material 31 provided in the second chamber 22, desorption of the fuel vapor is promoted. As a result, it is possible to compensate for low desorption property of the activated carbon 23(B) of high adsorption ability contained in the second chamber 22, whereby it is possible to reduce the blow-through amount due to the high adsorption ability in addition to reduction in the residual amount. The heat storage material 31 contained in the second chamber 22 may be replaced with a heating device such as an electric heater. Otherwise, it is also possible to use both a heat storage device (the heat storage material 31) and a heating device such as an electric heater.

The activated carbon 23(B) of high adsorption ability contained in the second chamber 22 is activated carbon having a high adsorption ability of 13 g/dL or more in terms of butane working capacity as measured by the ASTM method. According, the activated carbon 23(B) of high adsorption ability contained in the second chamber 22 can ensure a higher adsorption ability than a commonly used activated carbon.

Further, the adsorbent 23(A) contained in the first chamber 21 is activated carbon of lower adsorption ability in terms of butane working capacity as measured by the ASTM method as compared with the activated carbon 23(B) of high adsorption ability contained in the second chamber 22. Accordingly, it is possible to use a commonly used activated carbon as the adsorbent 23(A) in the first chamber 21.

### SECOND EXAMPLE

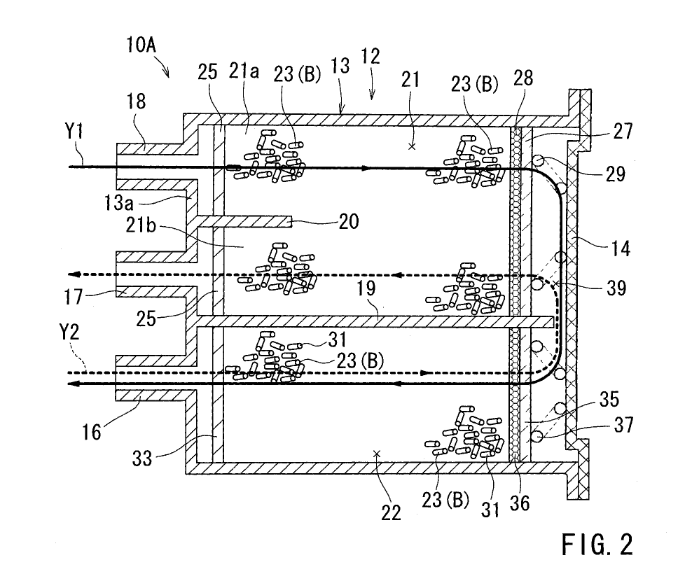

A second example will now be described. The second example is a modification of the first example described above, so the following description will be focused mainly on the modified portion. FIG. 2 is a sectional view of a canister 10A according to the second example.

As shown in FIG. 2, the canister 10A of the second example is different from the canister 10 of the first example in that the activated carbon 23(A) of low adsorption ability contained in the first chamber 21 of the canister 10 of the first example (See FIG. 1) is replaced with the activated carbon 23(B) of high adsorption ability. The activated carbon 23(B) is activated carbon having a high adsorption capacity equivalent to that of the activated carbon 23(B) contained in the second chamber 22 of the first example. Thus, the activated carbon 23(B) of high adsorption ability is contained in the first chamber 21, so that as compared with the case of using a commonly used activated carbon, it is possible to ensure a higher adsorption ability. The activated carbon 23(B) contained in the first chamber 21 of the second example may not be limited is to activated carbon having a high adsorption ability equivalent to that of the activated carbon 23(B) contained in the second chamber 22. Thus, as the activated carbon 23(B) contained in the first chamber 21 of this example, any other activated carbon may be used as long as it has a high adsorption ability of 13 g/dL or more in terms of butane working capacity as measured by the ASTM method. Preferably, the activated carbon 23(B) contained in the first chamber 21 and the activated carbon 23(B) contained in the second chamber 22 may have an equivalent specific heat.

### THIRD EXAMPLE

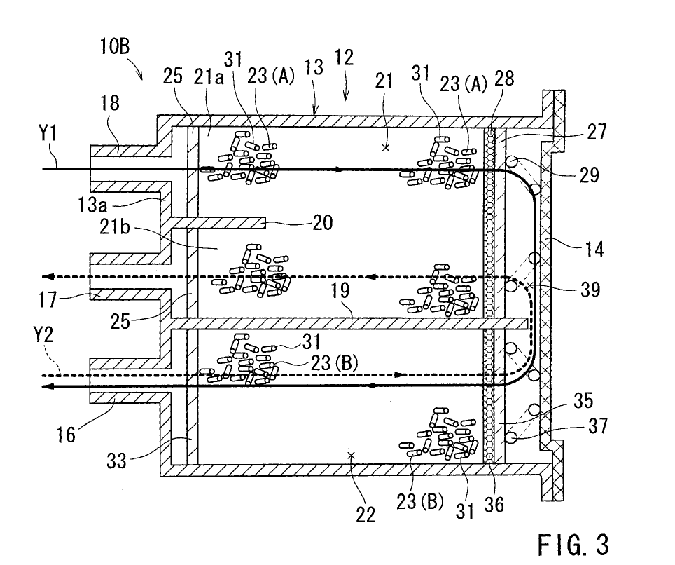

A third example will now be described. Also, the third example is a modification of the first example. FIG. 3 is a sectional view of a canister 10B according to the third example.

As shown in FIG. 3, the canister 10B of this example is different from the canister 10 of the first example (see FIG. 1) in that a mixture of the activated carbon 23(A) of low adsorption capacity and the heat storage material 31 is contained in the first chamber 21. The heat storage material 31 is one similar to that accommodated in the second chamber 22 in the first embodiment. Accordingly, it is possible to promote desorption of fuel vapor by the heat storage material 31 provided in the first chamber 21. Thus, it is possible to reduce the residual amount of fuel vapor resulting by the use of the activated carbon 23(A) of low adsorption ability in the first chamber 21. The heat storage material 31 serves as a “desorption promotion device” or a “heat storage device.” The heat storage material 31 contained in the first chamber 21 may be replaced with a heating device such as an electric heater. Further, it is also possible to use both the heat storage device (the heat storage material 31) and the heating device such as an electric heater.

### FOURTH EXAMPLE

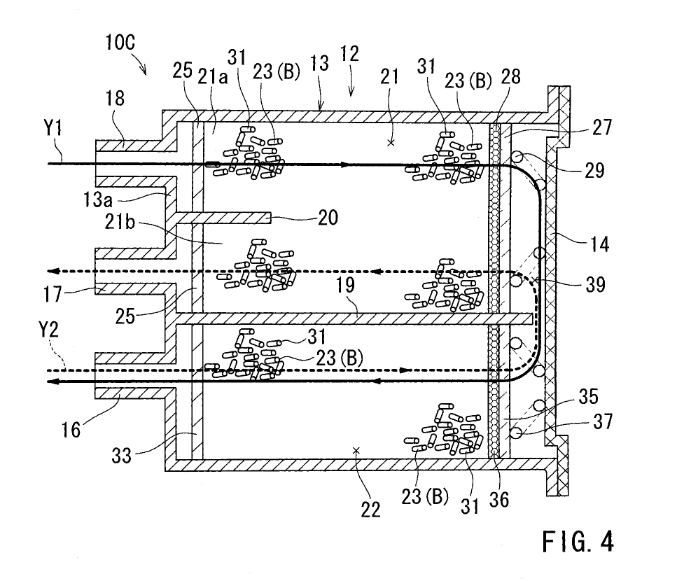

A fourth example will now be described. The fourth example is a modification of the second example. FIG. 4 is a sectional view of a canister 10C according to the fourth example.

As shown in FIG. 4, the canister 10C of the fourth example is different from the canister 10A of the second example (see FIG. 2) in that a mixture of the activated carbon 23(B) of high adsorption ability and the heat storage material 31 is contained in the first chamber 21. The heat storage material 31 is one similar to that accommodated in the second chamber 22 of the canister 10 of the first embodiment. Accordingly, it is possible to promote desorption of fuel vapor by the heat storage material 31 provided in the first chamber 21. Thus, it is possible to compensate for low desorption property of the activated carbon 23(B) of high adsorption ability contained in the first chamber 21, whereby it is possible to reduce the residual amount of fuel vapor. The heat storage material 31 in the first chamber 21 may be replaced with a heating device such as an electric heater. Further, it is also possible to use both a heat storage device (the heat storage material 31) and a heating device such as an electric heater.

### FIFTH EXAMPLE

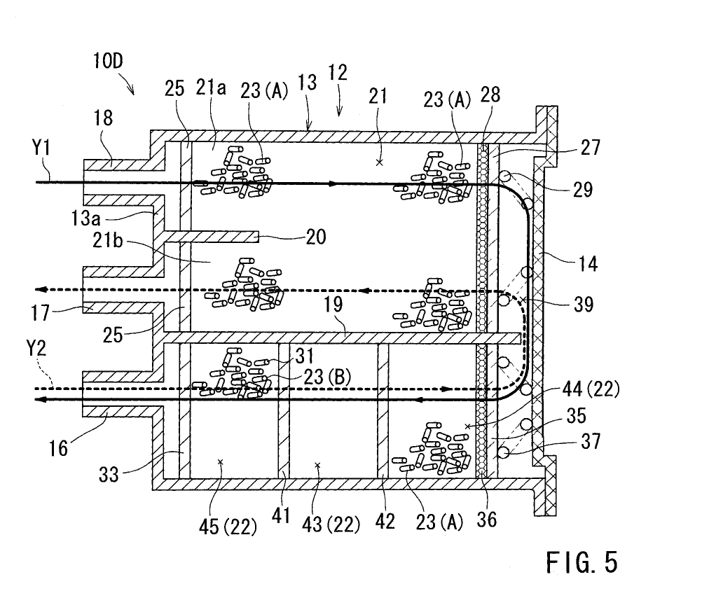

A fifth example will now be described. FIG. 5 is a sectional view of a canister 10D according to the fifth example.

As shown in FIG. 5, the canister 10D of the fifth example is different from the canister 10 of the first example (see FIG. 1) in that two front and rear air-permeable partition members 41 and 42 are disposed within the central region of the second chamber 22 so as to be spaced from each other by a predetermined distance in the air flowing direction (the left and right direction as seen in FIG. 5). Therefore, a hollow chamber 43 accommodating no adsorbent (activated carbon) is formed between the two partition members 41 and 42. The partition members 41 and 42 may be filters that are made of non-woven fabric, urethane foam or the like, or may be air-permeable plate members formed of lattice-like resin plate members or the like.

Due to the formation of the hollow chamber 43, the second chamber 22 is divided into two divisional chambers 44 and 45 with the hollow chamber 43 positioned therebetween. The divisional chamber 44 positioned on the rear side (the right-hand side in FIG. 5) accommodates the activated carbon 23(A) of low adsorption ability. The divisional chamber 45 positioned on the front side (the left-hand side in FIG. 5) accommodates a mixture of the activated carbon 23(B) of high adsorption ability and the heat storage material 31. In this example, the first chamber 21 and the rear-side divisional chamber 44 of the second chamber 22 serves as a “first adsorbent chamber”, while the front-side divisional chamber 45 of the second chamber 22 serves as a “second adsorbent chamber.”

According to this example, due to the hollow chamber 43 provided between the divisional chamber 44 on the rear side and the divisional chamber 45 on the front side of the second chamber 22, it is possible to prevent diffusion or movement of the fuel vapor from the front-side divisional chamber 44 to the rear-side divisional chamber 45. Also in this example, the activated carbon 23(A) in the rear-side divisional chamber 44 may be replaced with the activated carbon 23(B) of high adsorption ability. Further, it is also possible to accommodate a mixture of the heat storage material 31 and the activated carbon 23(A) of low adsorption ability (or the activated carbon 23(B) of high adsorption ability) within the rear-side divisional chamber 44

### SIXTH EXAMPLE

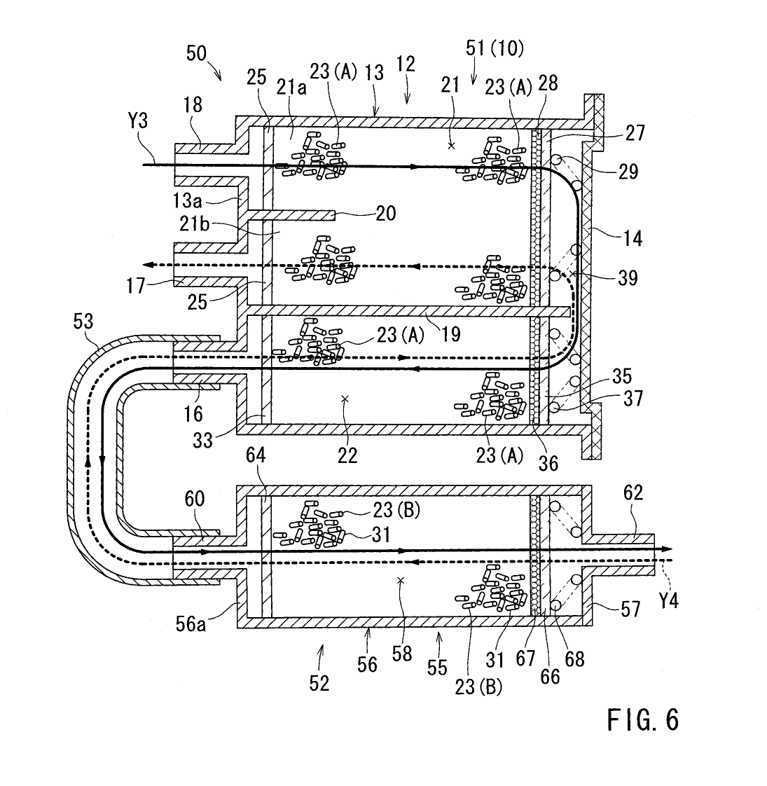

A sixth example will now be described. FIG. 6 is a sectional view of a canister 50 according to the sixth example. As shown in FIG. 6, the canister 50 includes a first canister 51, a second canister 52, and a connection pipe 53. As the first canister 51, the canister 10 according to the first example described above (See FIG. 1) may be used. However, the atmosphere port 16 of the canister 10 is changed to a connection port that is labeled with the same reference numeral 16. On end of the connection pipe 53 is connected to the connection port 16. The second chamber 22 of the first canister 51 accommodates the activated carbon 23(A) of low adsorption ability instead of the mixture of the activated carbon 23(B) and the heat storage material 31. In this example, the first chamber 21 and the second chamber 22 may serve a “first adsorbent chamber.”

The second canister 52 serves as a trap canister that is a separate unit from the first canister 51. The second canister 52 has a case 55. The case 55 is made of resin and includes a bottomed cylindrical tubular case member 56 and a cover member 57 configured to close the open end of the case member 56. The inner space of the case 55 is defined as a third chamber 58. In this example, the bottom side of the case member 56 is oriented forwards (to the left as seen in FIG. 6), and the cover member 57 is oriented rearwards (to the right as seen in FIG. 6). The second canister 52 is arranged on the left-hand side (the lower side as seen in FIG. 6) of the case 12 of the first canister 51 so as to be parallel thereto.

A connection port 60 is formed coaxially with an end plate 56a on the front side of the case member 56 and protrudes forwardly (to the left as seen in FIG. 6) therefrom. The connection port 60 is connected to the other end of the connection pipe 53. As a result, the second chamber 22 of the first canister 51 and the third chamber 58 of the case 55 communicate with each other via the connection pipe 53. The connection pipe 53 serves as a “piping member.”

An atmosphere port 62 is formed coaxially with the cover member 37 and protrudes rearwards (to the right as seen in FIG. 6) therefrom. The atmosphere port 62 communicates with the third chamber 58 and is open to the atmosphere.

A mixture of the activated carbon 23(B) of high adsorption ability and the heat storage material 31 is accommodated within the third chamber 58. The third chamber 58 serves as a “second adsorbent chamber.”

An adsorbent retaining filter 64 is disposed within the front end region of the third chamber 58 so as to be interposed between the front-side end plate 56a of the case member 56 and the mixture of the activated carbon 23(B) of high adsorption ability and the heat storage material 31. The filter 64 may be made of non-woven fabric. Further, a lattice-like air-permeable plate member 66 for pressing the adsorbent is fitted into the rear end region of the third chamber 58 so as to be movable in the forward and rearward direction (in the left and right direction as seen in FIG. 6). Further, an adsorbent retaining filter 67 is interposed between the air-permeable plate member 66 and the mixture of the activated carbon 23(B) of high adsorption ability and the heat storage material 31. The filter 67 may be made of urethane foam. Further, a spring 68 is interposed between the air-permeable plate member 66 and the cover member 57. The spring 68 resiliently forwardly presses the air-permeable plate member 66 to the left as seen in FIG. 6.

Next, the operation of the canister 50 (see FIG. 6) will now be described. During filling of fuel or during a normal state (e.g., during parking), a fuel vapor gas containing fuel vapor generated in the fuel tank (see the solid-line arrow Y1 in FIG. 6) is introduced into the first chamber 21 via the tank port 18 of the first canister 51. The fuel vapor gas then flows through the first chamber 21, the communication path 39, and the second chamber 22. During this process, the fuel vapor contained in the fuel vapor gas is adsorbed onto the activated carbon 23(A) of low adsorption ability contained in the first chamber 21 and the second chamber 22. Thereafter, the fuel vapor gas, which now substantially consists only of air, is introduced into the third chamber 58 via the connection pipe 53 and the connection port 60 of the second canister body 52. As the fuel vapor gas passes through the third chamber 58, fuel vapor still remained in the gas may be adsorbed onto the activated carbon 23(B) of high adsorption ability. Due to the latent heat of the heat storage material 31 contained in the third chamber 58, increase in temperature of the activated carbon 23(B) of high adsorption ability during adsorption of the fuel vapor can be suppressed, whereby adsorption of fuel vapor can be promoted. Eventually, air containing substantially no fuel vapor may be discharged into the atmosphere from the atmosphere port 62.

When the purge control valve is opened under the control of the electronic control unit (ECU) for the purging operation (for the purge control operation during driving of the engine), the intake negative pressure of the engine is introduced into the first chamber 21 via the purge port 17 of the first canister body 51, so that the atmosphere air flows through the second chamber 22, the communication passage 39, and the first chamber 21 via the third chamber 58 of the second canister body 52 and the connection pipe 53 in a direction opposite to the flow of the fuel vapor gas (see the dotted-line arrow Y4 in FIG. 6). Therefore, the fuel vapor is desorbed (purged) from the activated carbon 23(B) of high adsorption ability contained in the third chamber 58, and is also desorbed from the activated carbon 23(A) of low adsorption ability contained in the second chamber 22 and the first chamber 21. The desorbed fuel vapor is then supplied together with air to the intake passage of the engine from the purge port 17. During this process, the latent heat of the heat storage material 31 contained in the third chamber 58 may inhibit a reduction in the temperature of the activated carbon 23(B) of high adsorption ability during adsorption of the fuel vapor, and therefore, desorption of the fuel vapor can be promoted.

With the canister 50 described above, the first canister body 51 and the second canister body 52 can be arranged so as to be separated from each other. Further, due to incorporation of the connection pipe (piping member) 53 communicating between the first canister body 51 and the second canister body 52, it is possible to prevent diffusion or movement of fuel vapor from the first canister body 51 to the second canister body 52. Also in this example, the activated carbon 23(A) in the first chamber 21 and the second chamber 22 of the first canister body 51 may be replaced with the activated carbon 23(B) of high adsorption ability. Further, it is also possible to store a mixture of the heat storage material 31 and the activated carbon 23(A) of low adsorption ability or the activated carbon 23(B) of high adsorption ability both in the first chamber 21 and the second chamber 22 of the first canister body 51.

### SEVENTH EXAMPLE

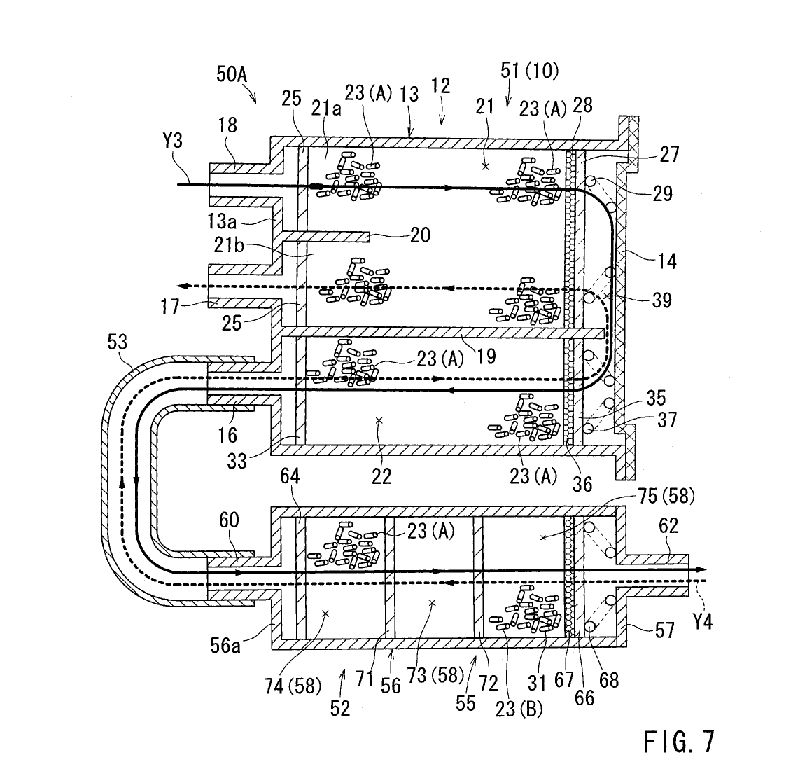

A seventh example will now be described with reference to FIG. 7 showing a sectional view of a canister 50A according to this example.

As shown in FIG. 7, the canister 50A of this example is different from the canister 50 of the sixth example (see FIG. 6) in that two front and rear air-permeable partition members 71 and 72 are disposed within the central portion of the third chamber 58 so as to be spaced from each other by a predetermined distance in the air flowing direction (the horizontal direction as seen in FIG. 7), so that a hollow chamber 73 accommodating no adsorbent (no activated carbon) is defined between the two partition members 71 and 72. The partition members 71 and 72 may be filters that are made of non-woven fabric, urethane foam or the like, or may be air-permeable plate members formed of lattice-like resin plate members or the like.

Due to the formation of the hollow chamber 73, the third chamber 58 is divided into two chambers with the hollow chamber 73 positioned therebetween. A divisional chamber 74 on the front side (the left-hand side in FIG. 7) accommodates the activated carbon 23(A) of low adsorption ability. A divisional chamber 75 on the rear side (the right-hand side in FIG. 7) accommodates a mixture of the activated carbon 23(B) of high adsorption ability and the heat storage material 31. In this example, the first chamber 21, the second chamber 22, and the front-side divisional chamber 74 of the third chamber 58 may serve as a “first adsorbent chamber.” The rear-side divisional chamber 75 of the third chamber 58 may serve as a “second adsorbent chamber.”

According to this example, due to the hollow chamber 73 provided between the divisional chamber 74 on the front side and the divisional chamber 75 on the rear side of the third chamber 58, it is possible to prevent diffusion or movement of the fuel vapor from the divisional chamber 74 on the front side to the divisional chamber 75 on the rear side. Also in this example, the activated carbon 23(A) in the divisional chamber 74 on the front side may be replaced with the activated carbon 23(B) of high adsorption ability. Further, in the divisional chamber 74 on the front side, it is possible to accommodate a mixture of the heat storage material 31 and the activated carbon 23(A) of low adsorption ability or the activated carbon 23(B) of high adsorption ability.

What is claimed is:

1. A canister comprising:
a canister case having a tank port communicating with an upper gaseous chamber of a fuel tank, a purge port communicating with an intake passage of an internal combustion engine, and an atmosphere port open to the atmosphere;
an adsorbent chamber defined in the canister case;
an adsorbent disposed in the adsorbent chamber;
wherein the adsorbent can adsorb fuel vapor as the fuel vapor flows from the tank port to the atmosphere port, and the adsorbent allows desorption of the fuel vapor 1 as air is drawn from the atmosphere port into the purge port,
wherein the adsorbent chamber includes a first adsorbent chamber and a second absorbent chamber, the first adsorbent chamber communicating with the tank port and the purge port, and the second adsorbent chamber communicating with the atmosphere port,
wherein the adsorbent disposed in the second adsorbent chamber comprises activated carbon having a high adsorption ability, and
a desorption promoting device disposed in the second adsorbent chamber and capable of promoting desorption of the fuel vapor.

2. The canister according to claim 1, wherein the activated carbon disposed in the second adsorbent chamber comprises activated carbon having a high adsorption ability of 13 g/dL or more in terms of butane working capacity as measured by the ASTM method.

3. The canister according to claim 2, wherein the adsorbent disposed in the first adsorbent chamber comprises activated carbon exhibiting a lower adsorption ability in terms of butane working capacity as measured by the ASTM method as compared with the activated carbon stored in the second adsorbent chamber.

4. The canister according to claim 3, further comprising a desorption promoting device disposed within the first adsorbent chamber and capable of promoting desorption of the fuel vapor.

5. The canister according to claim 2, wherein the adsorbent disposed in the first adsorbent chamber comprises activated carbon of high adsorption ability.

6. The canister according to claim 5, further comprising a desorption promoting device disposed within the first adsorbent chamber and capable of promoting desorption of the fuel vapor.

7. The canister according to claim 1, wherein a hollow chamber having no adsorbent disposed therein is provided between the first adsorbent chamber and the second adsorbent chamber.

8. The canister according to claim 1, wherein the canister case comprises:
a first case having the tank port and the purge port;
a second case having the atmosphere port; and
a piping member communicating between the first case and the second case.

9. The canister according to claim 1, wherein the desorption promoting device comprises a heat storage material mixed with the activated carbon disposed in the second adsorbent chamber.

10. The canister according to claim 4, wherein the desorption promoting device disposed within the first adsorbent chamber comprises a heat storage material mixed with the activated carbon disposed in the first adsorbent chamber.

11. The canister according to claim 6, wherein the desorption promoting device disposed within the first adsorbent chamber comprises a heat storage material mixed with the activated carbon disposed in the first adsorbent chamber.

12. A canister comprising:
a canister case;
an adsorbent chamber defined in the canister case;
an adsorbent disposed in the adsorbent chamber;
wherein the adsorbent can adsorb fuel vapor as the fuel vapor flows through the adsorbent chamber in a first direction, and the adsorbent allows desorption of fuel vapor as air flows through the adsorbent in a second direction opposite to the first direction,
wherein the adsorbent chamber includes a first adsorbent chamber and a second absorbent chamber communicating with each other, the first adsorbent chamber being disposed on an upstream side of the second adsorbent chamber with respect to the first direction;
wherein the adsorbent includes a first adsorbent disposed in the first adsorbent chamber and a second adsorbent disposed in the second adsorbent chamber; and
a desorption promoting device disposed in the second adsorbent chamber and capable of promoting desorption of fuel vapor from the second adsorbent.

13. The canister according to claim 12, wherein the first absorbent has a first adsorption ability, and the second absorbent has a second adsorption ability different from the first adsorption ability.

14. The canister according to claim 13, further comprising a desorption promoting device disposed in the first adsorbent chamber and capable of promoting desorption of fuel vapor from the first adsorbent.

15. The canister according to claim 12, wherein:
the canister case comprises a first case and a second case connected to each other via a communication member,
the first adsorbent chamber is defined in the first case; and
the second adsorbent chamber is defined in the second case.

16. A canister comprising:
a canister case;
an adsorbent chamber defined in the canister case;
an adsorbent disposed in the adsorbent chamber;
wherein the adsorbent can adsorb fuel vapor as the fuel vapor flows through the adsorbent chamber in a first direction, and the adsorbent allows desorption of fuel vapor as air flows through the adsorbent in a second direction opposite to the first direction,
wherein the adsorbent chamber includes a first adsorbent chamber and a second absorbent chamber communicating with each other, the first adsorbent chamber being disposed on an upstream side of the second adsorbent chamber with respect to the first direction;
wherein the adsorbent includes a first activated carbon disposed in the first adsorbent chamber and a second activated carbon disposed in the second adsorbent chamber, the second activated carbon having an adsorption ability of 13 g/dL or more in terms of butane working capacity as measured by the ASTM method; and
a heat storage material disposed in the second adsorbent chamber and mixed with the second activated carbon.
